(19) United States
(12) Patent Application Publication
(10) Pub. No.: US 2020/0301938 A1
(43) Pub. Date: Sep. 24, 2020

(54) CROSS-ORGANIZATION WORKSHEET SHARING

(71) Applicant: SIGMA COMPUTING, INC., San Francisco, CA (US)

(72) Inventors: JAMES L. GALE, SAN FRANCISCO, CA (US); JASON D. FRANTZ, SAN FRANCISCO, CA (US); MAX H. SEIDEN, SAN FRANCISCO, CA (US); KENNETH TRUONG, TEMPLE CITY, CA (US); ROBERT C. WOOLLEN, SAN RAFAEL, CA (US)

(21) Appl. No.: 16/820,911

(22) Filed: Mar. 17, 2020

Related U.S. Application Data
(60) Provisional application No. 62/820,342, filed on Mar. 19, 2019.

(51) Int. Cl. G06F 16/25; G06F 16/245; G06F 16/248; G06F 21/62; G06Q 50/28; G06F 40/18

(52) U.S. Cl. CPC G06F 16/254; G06F 16/245; G06F 16/248; H04L 67/10; G06Q 50/28; G06F 40/18; G06F 21/6218

(57) ABSTRACT

Cross-organization worksheet sharing including receiving, from a client, a data set configuration for a worksheet, wherein the data set configuration comprises permissions for a data set from a database stored on a cloud-based data warehouse managed by the client; generating worksheet metadata for the worksheet using the data set configuration; and in response to receiving, from a client system, a request for the worksheet: sending a database query to the cloud-based data warehouse, wherein the database query is generated using the worksheet metadata including the permissions for the data set; receiving, in response to the database query, the data set from the cloud-based data warehouse; and presenting, to the client system, the worksheet containing the data set using the data set configuration including limiting the presentation based on the permissions for the data set received from the client.

### CROSS-REFERENCE TO RELATED APPLICATION

This application is a non-provisional application for patent entitled to a filing date and claiming the benefit of earlier-filed U.S. Provisional Patent Application Ser. No. 62/820,342, filed Mar. 19, 2019.

### BACKGROUND

### Field of the Invention

The field of the invention is data processing, or, more specifically, methods, apparatus, and products for cross-organization worksheet sharing.

### Description of Related Art

Modern businesses may store large amounts of data in remote databases within cloud-based data warehouses. This data may be accessed using database query languages, such as structured query language (SQL). Few users, however, are able to fully utilize all information stored in the database. Further, manipulating the data stored in the database may require administrative access. Organizations managing such data may be unable to provide the data clearly to the members or customers of the organization.

### SUMMARY

Methods, systems, and apparatus for cross-organization worksheet sharing. Cross-organization worksheet sharing includes receiving, from a client, a data set configuration for a worksheet, wherein the data set configuration comprises permissions for a data set from a database stored on a cloud-based data warehouse managed by the client; generating worksheet metadata for the worksheet using the data set configuration; and in response to receiving, from a client system, a request for the worksheet: sending a database query to the cloud-based data warehouse, wherein the database query is generated using the worksheet metadata including the permissions for the data set; receiving, in response to the database query, the data set from the cloud-based data warehouse; and presenting, to the client system, the worksheet containing the data set using the data set configuration including limiting the presentation based on the permissions for the data set received from the client.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for cross-organization worksheet sharing according to embodiments of the present invention.

FIG. 2 sets forth a block diagram of an example system configured for cross-organization worksheet sharing according to embodiments of the present invention.

FIG. 3 sets forth a block diagram of an example system configured for cross-organization worksheet sharing according to embodiments of the present invention.

FIG. 4 sets forth a flow chart illustrating an exemplary method for cross-organization worksheet sharing according to embodiments of the present invention.

FIG. 5 sets forth a flow chart illustrating an exemplary method for cross-organization worksheet sharing according to embodiments of the present invention.

FIG. 6 sets forth a flow chart illustrating an exemplary method for cross-organization worksheet sharing according to embodiments of the present invention.

### DETAILED DESCRIPTION

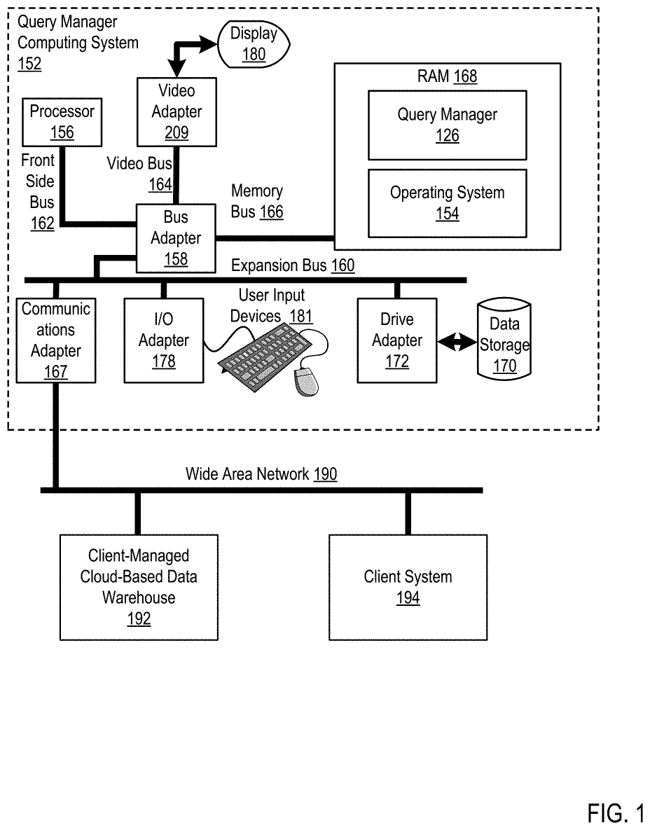

Exemplary methods, apparatus, and products for cross-organization worksheet sharing in accordance with the present invention are described with reference to the accompanying drawings, beginning with FIG. 1. FIG. 1 sets forth a block diagram of automated computing machinery comprising an exemplary computing system (152) configured for cross-organization worksheet sharing according to embodiments of the present invention. The computing system (152) of FIG. 1 includes at least one computer processor (156) or ‘CPU’ as well as random access memory (168) (RAM′) which is connected through a high speed memory bus (166) and bus adapter (158) to processor (156) and to other components of the computing system (152).

Stored in RAM (168) is an operating system (154). Operating systems useful in computers configured for cross-organization worksheet sharing according to embodiments of the present invention include UNIX™, Linux™, Microsoft Windows™, AIX™, IBM's i OS™, and others as will occur to those of skill in the art. The operating system (154) in the example of FIG. 1 is shown in RAM (168), but many components of such software typically are stored in non-volatile memory also, such as, for example, on data storage (170), such as a disk drive. Also stored in RAM is the query manager (126), a module for cross-organization worksheet sharing according to embodiments of the present invention.

The computing system (152) of FIG. 1 includes disk drive adapter (172) coupled through expansion bus (160) and bus adapter (158) to processor (156) and other components of the computing system (152). Disk drive adapter (172) connects non-volatile data storage to the computing system (152) in the form of data storage (170). Disk drive adapters useful in computers configured for cross-organization worksheet sharing according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing system (152) of FIG. 1 includes a communications adapter (167) for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for cross-organization worksheet sharing according to embodiments of the present invention include modems for wired dial-up communications, Ethernet (IEEE 802.3) adapters for wired data communications, and 802.11 adapters for wireless data communications.

The communications adapter (167) is communicatively coupled to a wide area network (190) that also includes a client-managed cloud-based data warehouse (192) and a client system (194). The client-managed cloud-based data warehouse (192) is a computing system or group of computing systems that hosts a database for access over the wide area network (190). The client system (194) is a computing system that accesses the database using the query manager (126) on the computing system (152).

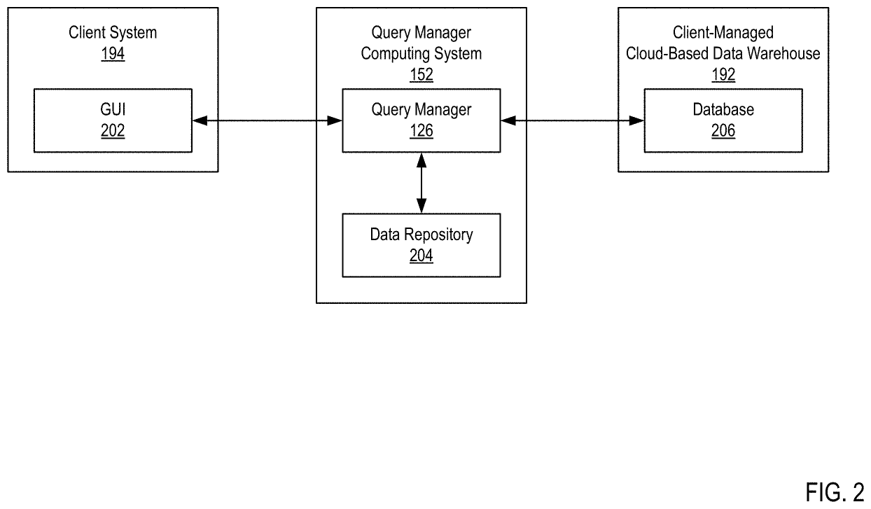

FIG. 2 shows an exemplary system for cross-organization worksheet sharing according to embodiments of the present invention. As shown in FIG. 2, the exemplary system includes a client computing system (194), a query manager computing system (152), and a client-managed cloud-based data warehouse (192). The client computing system (194) includes a graphical user interface (GUI) (202). The query manager computing system (152) includes a query manager (126) and a data repository (204). The client-managed cloud-based data warehouse (192) includes a database (206).

The GUI (202) is a user interface that presents a data set and graphical elements to a user and receives user input from the user. The GUI (202) may be presented, in part, by the query manager (126) and displayed on a client system (194) (e.g., on a system display or mobile touchscreen). The GUI (202) may be an Internet application hosted on the query manager computing system (152) and presented on the client computing system (194). The GUI (202) may be embedded within a website hosted by another entity, such as the client.

The client is a system or group of systems that does not manage and is exterior to the query manager computing system (152). The client manages the client-managed cloud-based data warehouse (192) in that the client has administrative access or ability to grant administrative access to the database (206). Limited access to the database (206) may be granted to the query manager (126) by the client. The query manager (126) may have limited access, such as read-only access, and may not have administrative access to the database (206) that would grant the query manager (126) the ability to write to the tables in the database (206).

The client may enlist the query manager computing system (152) (or the entity managing the query manager computing system (152)) to present data sets in the form of worksheets to a user of the client system (194). Specifically, the client may enlist the query manager (126) to present data sets in a particular manner (or with the ability to manipulate the presentation) using a data set configuration.

The client system (194) may be under the control of a customer of the client. For example, the client system (194) may be as system accessing a website managed by the client, and the website may include an embedded link to the GUI (202) through which a worksheet is presented by the query manager (126). Alternatively, the client system (194) may be a workstation managed by the client through which an employee of the client accesses the GUI (202).

The GUI (202) presents, in part, worksheets to a user. A worksheet is a presentation of a data set from a database (206). A referencing worksheet is a worksheet that is linked from another worksheet (referred to as a data source worksheet). The referencing worksheet inherits the data set presented in the data source worksheet (i.e., data not excluded from presentation). The referencing worksheet may also inherit the results of formula applied to other data but not the formulas themselves. The referencing worksheet may be limited to the data set presented or otherwise made available in the data source worksheet (unless the user generating the referencing worksheet has access to excluded data in the database). A referencing worksheet may be linked from any number of data sources, including multiple data source worksheets. Changes made to the data source worksheet are reflected in the referencing worksheet. For example, if a column is added to and presented in the data source worksheet, the column would then appear in or be available to the referencing worksheet. Conversely, if a column is removed from the source worksheet, then the column would then disappear from, or become unavailable to, the referencing worksheet.

The GUI (202) presents a worksheet using the information in the worksheet metadata. Worksheet metadata, such as referencing worksheet metadata and data source metadata, is data that describes a worksheet. Specifically, the worksheet metadata may include a description of the data set, the formulas to be applied to the data set, and the presentation structure of the data set. The description of the data set describes which data is to be requested via the database query. The description of the data set may include which columns and rows of data are to be retrieved from the database (206) via the database query. The formulas to be applied to the data set may include the manipulations of the data in the columns and rows received in the data set. Such manipulations may include calculation columns that apply a formula to data in the data set.

The presentation structure of the data set may include presentation selections made by a user. The presentation structure may include the hierarchical relationship between the columns, filters applied to the data, and the manner in which the data is sorted. The presentation structure of the data set may also include the GUI visibility of particular data within the data set. GUI visibility may be altered based on filter settings of the data or on the visibility status (e.g., hidden or not hidden) of a column within the data set. The presentation structure of the data set may also include the formatting of the worksheet, such as the size of rows and columns.

Worksheet metadata may also include a reference to, or identifier of, the worksheet metadata for a different worksheet. For example, the worksheet metadata for a referencing worksheet may include a reference to the data source worksheet from which the referencing worksheet was linked. Further, referencing worksheet metadata may lack a reference to the database or data set upon which the data source worksheet was built. Rather, the referencing worksheet metadata may only include a reference to the data source worksheet metadata, and that reference is used to retrieve the data source worksheet metadata. Because the referencing worksheet metadata may lack a reference to the database or data set, both the referencing worksheet metadata and data source worksheet metadata are used to generate the database query.

Worksheet metadata may be generated using a data set configuration. Like the worksheet metadata, the data set configuration may include a description of the data set, the formulas to be applied to the data set, and the presentation structure of the data set. The data set configuration may also include permissions for the data set. Permissions for the data set may include a description of the particular data set that may be viewed, a description of the portion of the data set may be viewed, a description of the types of presentations available to view the data set, and a description of the authenticated client systems authorized to access the data set. Permissions for the data set may also include a description of a subset of the data set to exclude from the presentation. Excluding a subset of the data set from the presentation may include excluding the subset of the data in the database query or removing the subset of the data from the worksheet presented to the client system.

The query manager (126) is hardware, software, or an aggregation of hardware and software configured to retrieve worksheet metadata, evaluation worksheet metadata, and generate a database query using the worksheet metadata. The query manager (126) may be part of a database query generator that generates the database query. The database query may be populated based on the worksheet metadata.

The query manager (126) may be enlisted by the client to manage the presentation of a data set from the database on the client-managed cloud-based data warehouse (192). The query manager (126) may then service requests for the worksheets by generating database queries and issuing the database queries to the database (206). The data set received from the database (206) my then be presented as a worksheet via the GUI (202). The query manager (126) may also track the requests and computational capacity necessary to service the requests. The tracked requests may then be used to create an invoice for the client. The tracked request may also be deducted from an account associated with the client.

The data repository (204) is a repository of worksheet metadata. Worksheet metadata may be retrieved from the data repository (204) using a reference to, or identifier of, the worksheet metadata. The database (206) is a collection of data and a management system for the data. The management system may receive database queries, such as structure query language (SQL) queries, and respond to queries with a data set.

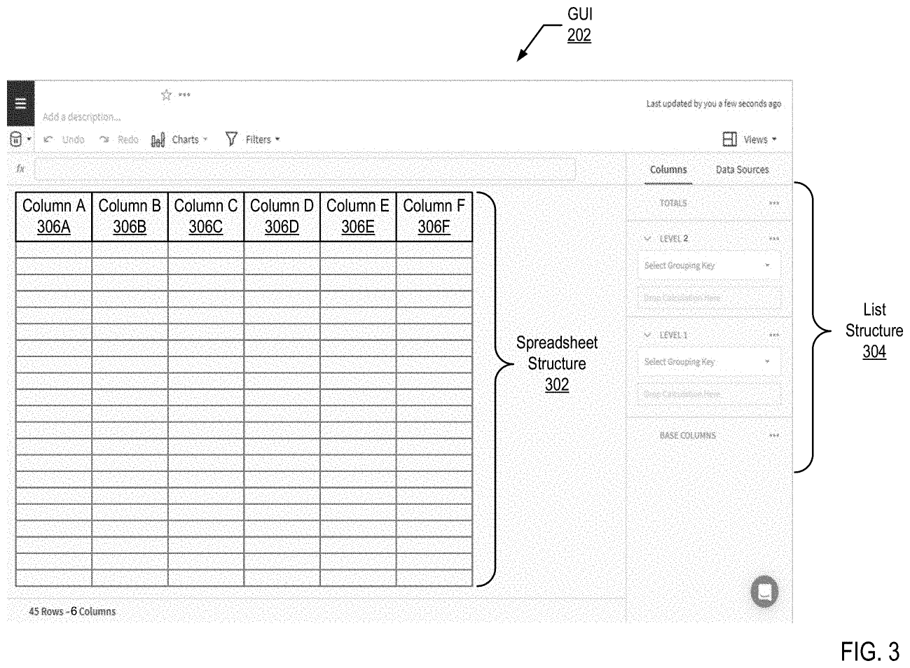

FIG. 3 shows an exemplary system for cross-organization worksheet sharing according to embodiments of the present invention. As shown in FIG. 3, the exemplary GUI (202) includes a spreadsheet structure (302) and a list structure (304). The spreadsheet structure (302) includes a data set (shown as empty rows) with six columns (column A (306A), column B (306B), column C (306C), column D (306D), column E (306E), column F (306F)).

The spreadsheet structure (302) is a graphical element and organizing mechanism for the data set. The spreadsheet structure (302) displays the data within the data set as rows of data organized by columns (column A (306A), column B (306B), column C (306C), column D (306D), column E (306E), column F (306F)). The columns delineate different categories of the data in each row of the data set. The columns may also be calculations using other columns in the data set.

The list structure (304) is a graphical element used to define and organize the hierarchical relationships between the columns (column A (306A), column B (306B), column C (306C), column D (306D), column E (306E), column F (306F)) of the data set. The term “hierarchical relationship” refers to subordinate and superior groupings of columns. For example, a database may include rows for an address book, and columns for state, county, city, and street. A data set from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The list structure (304) presents a dimensional hierarchy to the user. Specifically, the list structure (304) presents levels arranged hierarchically across at least one dimension. Each level within the list structure (304) is a position within a hierarchical relationship between columns (column A (306A), column B (306B), column C (306C), column D (306D), column E (306E), column F (306F)). The keys within the list structure (304) identify the one or more columns that are the participants in the hierarchical relationship. Each level may have more than one key.

One of the levels in the list structure (304) may be a base level. Columns selected for the base level provide data at the finest granularity. One of the levels in the list structure (304) may be a totals or root level. Columns selected for the totals level provide data at the highest granular level. For example, the totals level may include a field that calculates the sum of each row within a single column of the entire data set (i.e., not partitioned by any other column).

The GUI (202) may enable a user to drag and drop columns (column A (306A), column B (306B), column C (306C), column D (306D), column E (306E), column F (306F)) into the list structure (304). The order of the list structure (304) may specify the hierarchy of the columns relative to one another. A user may be able to drag and drop the columns in the list structure (304) at any time to redefine the hierarchical relationship between columns. The hierarchical relationship defined using the columns selected as keys in the list structure (304) may be utilized in charts such that drilling down (e.g., double click on a bar), enables a new chart to be generated based on a level lower in the hierarchy.

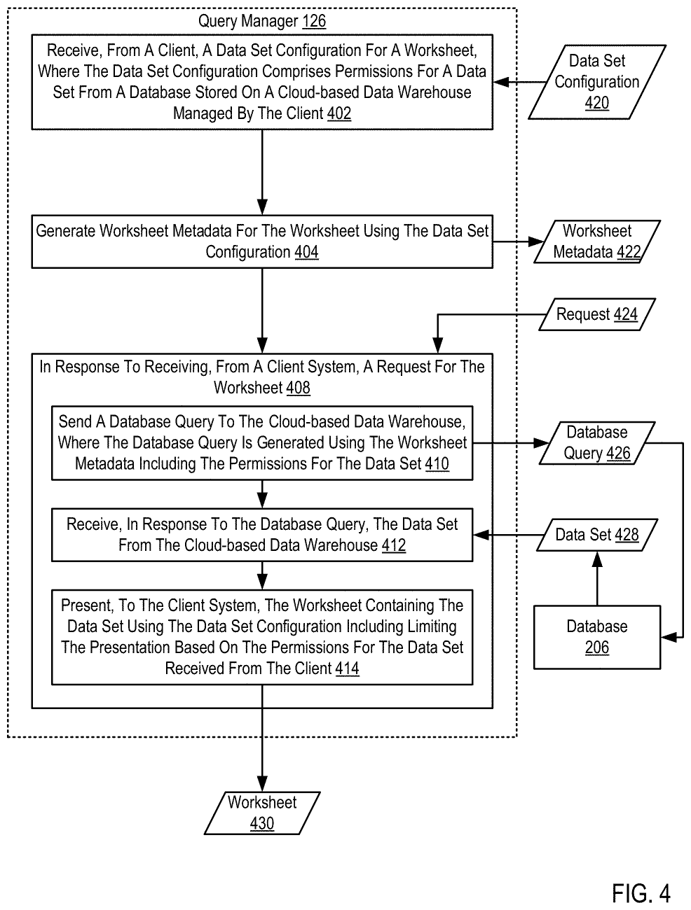

For further explanation, FIG. 4 sets forth a flow chart illustrating an exemplary method for cross-organization worksheet sharing according to embodiments of the present invention that includes receiving (402), from a client, a data set configuration (420) for a worksheet (430), wherein the data set configuration (420) comprises permissions for a data set (428) from a database (206) stored on a cloud-based data warehouse managed by the client. Receiving (402), from a client, a data set configuration (420) for a worksheet (430), wherein the data set configuration (420) comprises permissions for a data set (428) from a database (206) stored on a cloud-based data warehouse managed by the client may be carried out by the query manager (126) obtaining the data set configuration (420) from a system authorized by the client to configure a worksheet with the data set configuration (420). The client from whom the data set configuration is received may be an entity or system with a higher level of access to the database (206) than the client system. Additionally, the client from whom the data set configuration is received may be an entity or system able to restrict access by the client system to a worksheet. The data set configuration (420) may be in the form of a configuration of a worksheet. Further, the worksheet may be a referencing worksheet linked from a data source worksheet created by the client.

The method of FIG. 4 further includes generating (404) worksheet metadata (422) for the worksheet (430) using the data set configuration (420). Generating (404) worksheet metadata (422) for the worksheet (430) using the data set configuration (420) may be carried out by the query manager (126) populating worksheet metadata with the data set configuration (420) that includes the permissions. The permissions may be implemented using a data source worksheet and a referencing worksheet. For example, columns may be hidden in a data source worksheet and the referencing worksheet may be provided to the client system.

The method of FIG. 4 further includes receiving (408), from a client system, a request (424) for the worksheet (430). Receiving (408), from a client system, a request (424) for the worksheet (430) may be carried out by the query manager (126) detecting that a client system has requested the worksheet (430). As discussed above, the client system may be as system accessing a website managed by the client, and the website may include an embedded link to the GUI through which a worksheet is presented by the query manager (126). Alternatively, the client system may be a workstation managed by the client through which an employee of the client accesses the GUI.

The method of FIG. 4 further includes sending (410) a database query (426) to the cloud-based data warehouse, wherein the database query (426) is generated using the worksheet metadata (422) including the permissions for the data set (428). Generating the database query (426) using the worksheet metadata (422) and permissions may be carried out by the query manager (126) translating the description of the data set, the formulas to be applied to the data set, and the presentation structure of the data set in the worksheet metadata into a database query. The database query (422) may be an SQL statement. Sending (410) a database query (426) to the cloud-based data warehouse may be carried out by the query manager (126) sending the generated database query (426) over a wide area network to the database (206) on the cloud-based data warehouse.

The method of FIG. 4 further includes receiving (412), in response to the database query (426), the data set (428) from the cloud-based data warehouse. Receiving (412), in response to the database query (426), the data set (428) from the cloud-based data warehouse may be carried out by the query manager (126) obtaining the data set (428) from the database (206).

The method of FIG. 4 further includes presenting (414), to the client system, the worksheet (430) containing the data set (428) using the data set configuration (420) including limiting the presentation based on the permissions for the data set (428) received from the client. Presenting (414), to the client system, the worksheet (430) containing the data set (428) using the data set configuration (420) may be carried out by the query manager (126) generating the worksheet (430) from the worksheet metadata (422) and received data set (428). Limiting the presentation based on the permissions for the data set (428) received from the client may be carried out by the query manager (126) manipulating the worksheet (430) presenting the data set to exclude portions of the data set based on the permissions. Limiting the presentation based on the permissions may include, for example, filtering the data set to remove a portion of the data set or hiding columns in the worksheet (430).

Consider the following example. An inventory specialist at a widget company may want to create a sales worksheet for the sales staff to view the current inventory of widgets. Using her administrative access account, the inventory specialist sends a data set configuration for a data set that includes data describing the current inventory. The data set configuration may describe that the sales worksheet should present a row for each widget currently in inventory, widgets not in inventory but expected to be replenished, and discontinued widgets. The sales worksheet may also present columns for the widget name, amount in inventory, date that more widgets of that type will be available (if applicable), and the date that the widget was discontinued (if applicable). The data set configuration may also include permissions describing that the sales worksheet may be manipulated to sort the rows based on either the widget name or amount in inventory columns. The data set configuration may also include permissions describing that the sales worksheet may be filtered to exclude discontinued widgets. The data set configuration may also include permissions describing that only computing systems with the client's domain may access the sales worksheet.

Continuing with the example, in response to receiving the data set configuration, the query manager (126) generates sales worksheet metadata for the sales worksheet using the data set configuration. The sales worksheet metadata may then be stored in the data repository on the query manager computing system. At some later point, the query manager (126) receives a request for the worksheet from a client system within the client's domain operated by a salesperson. In response to receiving the request for the sales worksheet, the query manager (126) verifies that the request is from a client system within the client's domain and generates a database query using the worksheet metadata and sends the database query to the cloud-based data warehouse managed by the widget company.

Continuing with the example, the query manager (126) receives the data set in response to the data query and generates the sales worksheet from the data set and the worksheet metadata. The presentation of the sales worksheet via the GUI on the salesperson's client system is limited based on the permissions received from the inventory specialist. Specifically, the sales worksheet may only be sorted by the rows based on either the widget name or amount in inventory columns and the sales worksheet may only be filtered to exclude discontinued widgets.

As another example, assume that the inventory specialist wants to create a public worksheet embedded in a page on the client's website. The public worksheet would list only the current inventory without displaying widgets that are not in inventory or have been discontinued. Using her administrative access account, the inventory specialist sends a data set configuration for a data set that includes data describing the current inventory. The data set configuration may be sent in the form of creating a referencing worksheet linked from the sales worksheets (as a data source worksheet). Specifically, the inventory specialist may create a referencing worksheet that excludes the columns for the date that more widgets of that type will be available and the date that the widget was discontinued (if applicable). The referencing worksheet would also filter out the discontinued widgets and widgets that have an amount in inventory of zero. The data set configuration may also include permissions describing that the public worksheet may not be sorted or filtered in any way. The data set configuration may also include permissions describing that any computing system may access the public worksheet.

Continuing with the example, in response to receiving the second data set configuration as a referencing worksheet, the query manager (126) generates public worksheet metadata for the public worksheet using the data set configuration. The public worksheet metadata may then be stored in the data repository on the query manager computing system. At some later point, the query manager (126) receives a request for the public worksheet from a client system that is a user outside of the client's domain but attempting to retrieve a page from the client's website with an embedded link to the public worksheet. In response to receiving the request for the public worksheet, the query manager (126) generates a database query using the public worksheet metadata and sends the database query to the cloud-based data warehouse managed by the widget company.

Continuing with the example, the query manager (126) receives the data set in response to the data query and generates the public worksheet from the data set and the worksheet metadata. The presentation of the public worksheet via the GUI on the user's computing system is limited based on the permissions received from the inventory specialist. Specifically, the public worksheet may not be sorted or filtered, and does not display discontinued widgets and widgets that have an amount in inventory of zero.

The above limitations improve the operation of the computer system by generating database queries and presenting worksheet using data sets from a database. This is accomplished by receiving a data set configuration from a client, generating worksheet metadata from the data set configuration, and providing, to a client system, a worksheet using the data set configuration.

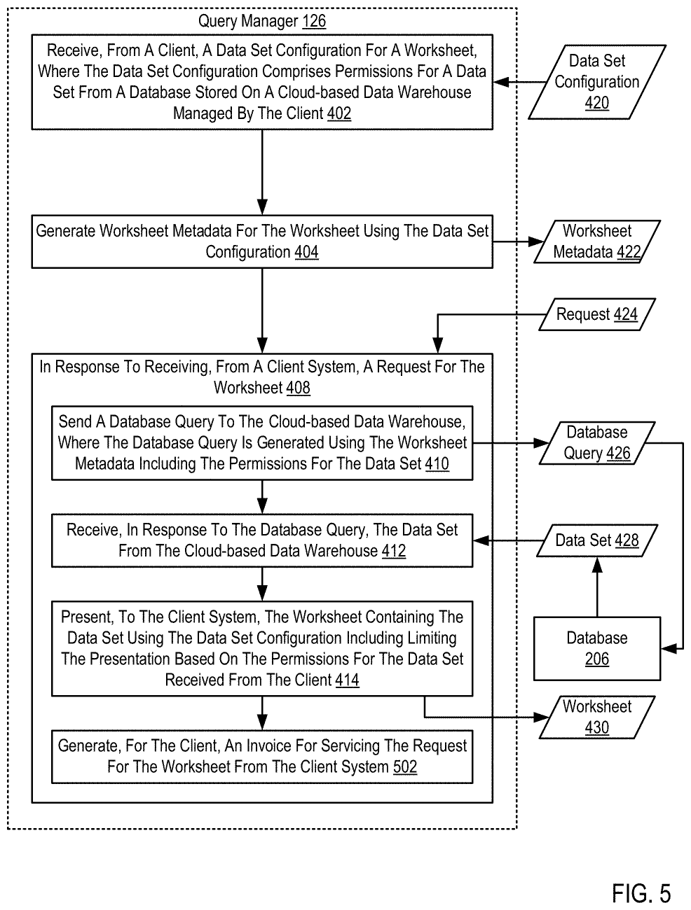

For further explanation, FIG. 5 sets forth a flow chart illustrating a further exemplary method for cross-organization worksheet sharing according to embodiments of the present invention that includes receiving (402), from a client, a data set configuration (420) for a worksheet (430), wherein the data set configuration (420) comprises permissions for a data set (428) from a database (206) stored on a cloud-based data warehouse managed by the client; generating (404) worksheet metadata (422) for the worksheet (430) using the data set configuration (420); and in response to receiving (408), from a client system, a request (424) for the worksheet (430): sending (410) a database query (426) to the cloud-based data warehouse, wherein the database query (426) is generated using the worksheet metadata (422) including the permissions for the data set (428); receiving (412), in response to the database query (426), the data set (428) from the cloud-based data warehouse; and presenting (414), to the client system, the worksheet (430) containing the data set (428) using the data set configuration (420) including limiting the presentation based on the permissions for the data set (428) received from the client.

The method of FIG. 5 differs from the method of FIG. 4, however, in that the method of FIG. 5 further includes generating (502), for the client, an invoice for servicing the request (424) for the worksheet (430) from the client system. Generating (502), for the client, an invoice for servicing the request (424) for the worksheet (430) from the client system may be carried out by the query manager (126) tracking the computational resources required to service each request for the worksheet and storing the tracked computational resources with an identifier of the client. Periodically, the tracked computational resources may be compiled into a total tracked computational resources utilized over a period of time. From the total tracked computational resources utilized over a period of time, an invoice may be generated through which the query manager (126) may be compensated for the computational resources.

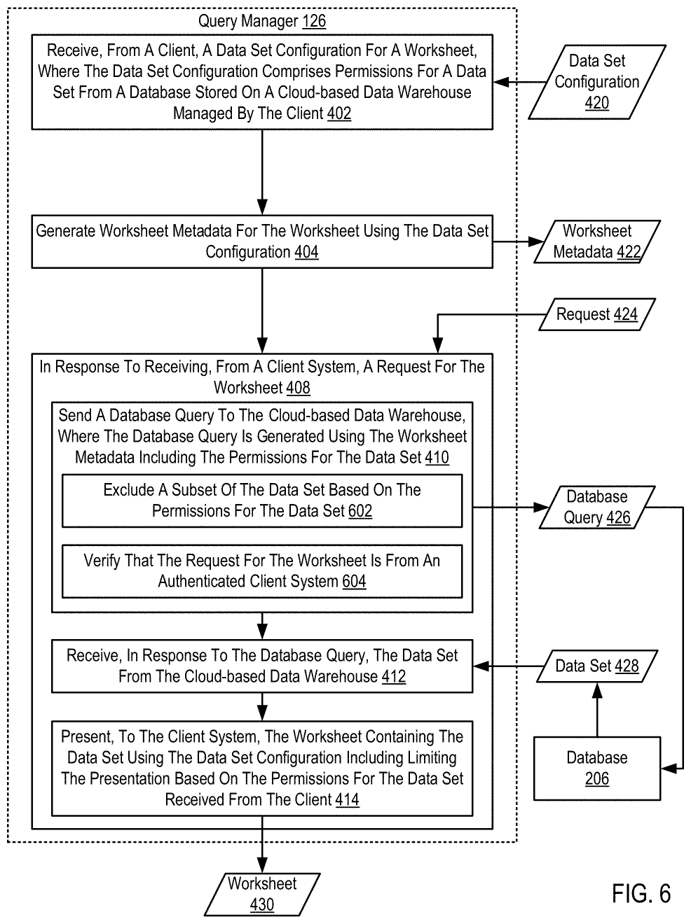

For further explanation, FIG. 6 sets forth a flow chart illustrating a further exemplary method for cross-organization worksheet sharing according to embodiments of the present invention that includes receiving (402), from a client, a data set configuration (420) for a worksheet (430), wherein the data set configuration (420) comprises permissions for a data set (428) from a database (206) stored on a cloud-based data warehouse managed by the client; generating (404) worksheet metadata (422) for the worksheet (430) using the data set configuration (420); and in response to receiving (408), from a client system, a request (424) for the worksheet (430): sending (410) a database query (426) to the cloud-based data warehouse, wherein the database query (426) is generated using the worksheet metadata (422) including the permissions for the data set (428); receiving (412), in response to the database query (426), the data set (428) from the cloud-based data warehouse; and presenting (414), to the client system, the worksheet (430) containing the data set (428) using the data set configuration (420) including limiting the presentation based on the permissions for the data set (428) received from the client.

The method of FIG. 6 differs from the method of FIG. 4, however, in that sending (410) a database query (426) to the cloud-based data warehouse, wherein the database query (426) is generated using the worksheet metadata (422) including the permissions for the data set (428) includes excluding (602) a subset of the data set (428) based on the permissions for the data set (428); and verifying (604) that the request (424) for the worksheet (430) is from an authenticated client system.

Excluding (602) a subset of the data set (428) based on the permissions for the data set (428) may be carried out by the query manager (126) selecting the subset of the data set (428) for exclusion and generating the database query (426) without including in the query the subset of the data set (428). The permissions may describe excluding the subset of the data in the database query. Specifically, the permissions may describe the subset of the data that should not be requested in the database query (426).

Removing the subset of the data from the worksheet presented to the client system may include manipulating the worksheet (430) presenting the data set to remove the subset of the data set based on the permissions. The permission may describe, for example, filtering the data set to remove a portion of the data set or hiding columns in the worksheet (430).

Verifying (604) that the request (424) for the worksheet (430) is from an authenticated client system may be carried out by the query manager (126) comparing the credentials or source information for the client system to the permissions received from the client. If the credentials or source information from the client system do not match the authenticated client systems described in the permissions, the query manager (126) may respond to the request for the worksheet with an error.

In view of the explanations set forth above, readers will recognize that the benefits of cross-organization worksheet sharing according to embodiments of the present invention include:
Improving the operation of a computing system by generating database queries and presenting worksheet using data sets from a database, increasing computing system usability and functionality.
Improving the operation of a computing system by allowing complex database query generation to be offloaded to a query manager, increasing computing system efficiency and usability.

Exemplary embodiments of the present invention are described largely in the context of a fully functional computer system for cross-organization worksheet sharing. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of cross-organization worksheet sharing, the method comprising:
receiving, from a client, a data set configuration for a worksheet, wherein the data set configuration comprises permissions for a data set from a database stored on a cloud-based data warehouse managed by the client;
generating worksheet metadata for the worksheet using the data set configuration; and
in response to receiving, from a client system, a request for the worksheet:
sending a database query to the cloud-based data warehouse, wherein the database query is generated using the worksheet metadata including the permissions for the data set;
receiving, in response to the database query, the data set from the cloud-based data warehouse; and
presenting, to the client system, the worksheet containing the data set using the data set configuration including limiting the presentation based on the permissions for the data set received from the client.

2. The method of claim 1, further comprising:
generating, for the client, an invoice for servicing the request for the worksheet from the client system.

3. The method of claim 1, wherein sending the database query to the cloud-based data warehouse comprises excluding a subset of the data set based on the permissions for the data set.

4. The method of claim 1, wherein sending the database query to the cloud-based data warehouse comprises verifying that the request for the worksheet is from an authenticated client system.

5. The method of claim 1, wherein the permissions describe at least one selected from a group consisting of excluding a subset of the data in the database query and removing a subset of the data from the worksheet presented to the client system.

6. The method of claim 1, wherein receiving the request for the worksheet from the client system comprises receiving the request via a webpage hosted by the client.

7. The method of claim 1, wherein the worksheet is a referencing worksheet linked from a data source worksheet created by the client.

8. An apparatus for cross-organization worksheet sharing, the apparatus comprising a computer processor, a computer memory operatively coupled to the computer processor, the computer memory having disposed within it computer program instructions that, when executed by the computer processor, cause the apparatus to carry out the steps of:
receiving, from a client, a data set configuration for a worksheet, wherein the data set configuration comprises permissions for a data set from a database stored on a cloud-based data warehouse managed by the client;
generating worksheet metadata for the worksheet using the data set configuration; and
in response to receiving, from a client system, a request for the worksheet:
sending a database query to the cloud-based data warehouse, wherein the database query is generated using the worksheet metadata including the permissions for the data set;
receiving, in response to the database query, the data set from the cloud-based data warehouse; and
presenting, to the client system, the worksheet containing the data set using the data set configuration including limiting the presentation based on the permissions for the data set received from the client.

9. The apparatus of claim 8, wherein the computer program instructions further cause the apparatus to carry out the steps of:
generating, for the client, an invoice for servicing the request for the worksheet from the client system.

10. The apparatus of claim 8, wherein sending the database query to the cloud-based data warehouse comprises excluding a subset of the data set based on the permissions for the data set.

11. The apparatus of claim 8, wherein sending the database query to the cloud-based data warehouse comprises verifying that the request for the worksheet is from an authenticated client system.

12. The apparatus of claim 8, wherein the permissions describe at least one selected from a group consisting of excluding a subset of the data in the database query and removing a subset of the data from the worksheet presented to the client system.

13. The apparatus of claim 8, wherein receiving the request for the worksheet from the client system comprises receiving the request via a webpage hosted by the client.

14. The apparatus of claim 8, wherein the worksheet is a referencing worksheet linked from a data source worksheet created by the client.

15. A computer program product for cross-organization worksheet sharing, the computer program product disposed upon a computer readable medium, the computer program product comprising computer program instructions that, when executed, cause a computer to carry out the steps of:
receiving, from a client, a data set configuration for a worksheet, wherein the data set configuration comprises permissions for a data set from a database stored on a cloud-based data warehouse managed by the client;
generating worksheet metadata for the worksheet using the data set configuration;
in response to receiving, from a client system, a request for the worksheet:
sending a database query to the cloud-based data warehouse, wherein the database query is generated using the worksheet metadata including the permissions for the data set;
receiving, in response to the database query, the data set from the cloud-based data warehouse; and
presenting, to the client system, the worksheet containing the data set using the data set configuration including limiting the presentation based on the permissions for the data set received from the client.

16. The computer program product of claim 15, wherein the computer program instructions further cause the computer to carry out the steps of:
generating, for the client, an invoice for servicing the request for the worksheet from the client system.

17. The computer program product of claim 15, wherein sending the database query to the cloud-based data warehouse comprises excluding a subset of the data set based on the permissions for the data set.

18. The computer program product of claim 15, wherein sending the database query to the cloud-based data warehouse comprises verifying that the request for the worksheet is from an authenticated client system.

19. The computer program product of claim 15, wherein the permissions describe at least one selected from a group consisting of excluding a subset of the data in the database query and removing a subset of the data from the worksheet presented to the client system.

20. The computer program product of claim 15, wherein receiving the request for the worksheet from the client system comprises receiving the request via a webpage hosted by the client.
